(19) United States
(12) Patent Application Publication
(10) Pub. No.: US 2007/0300255 A1
(43) Pub. Date: Dec. 27, 2007

(54) ELECTRONIC PROGRAM GUIDE IN A RECEIVER-DECODER APPARATUS

(75) Inventor: Mark LONDERO, Alton (GB)

Correspondence Address: OBLON, SPIVAK, MCCLELLAND MAIER & NEUSTADT, P.C., 1940 DUKE STREET, ALEXANDRIA, VA, 22314, US

(73) Assignee: SONY UNITED KINGDOM LIMITED, Weybridge (GB)

(21) Appl. No.: 11/762,364

(22) Filed: Jun. 13, 2007

(30) Foreign Application Priority Data
Jun. 21, 2006 (GB) 0612325.1

(51) Int. Cl. H04N 5/445; H04N 7/173; H04N 7/10; G06F 3/00; G06F 13/00; H04N 7/025

(52) U.S. Cl. 725/42; 725/100; 725/32; 725/39; 725/44

(57) ABSTRACT

A receiver-decoder apparatus has a video interface to which is connected a module which has a network interface capable of receiving a video signal from a network and which supplies that video signal through the video interface. The receiver-decoder apparatus selectively supplies to a decoder circuit either a broadcast television signal received from a receiver circuit or a video signal received from a video interface. The receiver-decoder apparatus extracts signalling data broadcast with the broadcast television signal and generates an electronic program guide including a list of the services available for reception by the receiver circuit and events in respect of those services. The electronic program guide includes at least one extra entry as a notional service in said list of services in respect of the video signal supplied from the video interface.

### BACKGROUND OF THE INVENTION

(1) Field of the Invention

The present invention relates generally to digital television and specifically to a receiver-decoder for receiving and decoding a broadcast digital television signal.

(2) Description of Related Art

Digital television signals are broadcast in encoded form, for example in accordance with the MPEG-2 or MPEG-4 standard. Reception is performed by a receiver-decoder apparatus which includes a receiver circuit which receives the broadcast television signal and a decoder circuit which decodes the television signal into a format in which allowing display by a display device. The receiver-decoder device may be a television incorporating the display device or may be a separate apparatus, such as a set-top box, which supplies the decoded television signal to television.

An Electronic Program Guide (EPG) is a guide displayed on the display device of the television apparatus to show a list of television programs (hereinafter called “events”) which are available to watch on the various television channels (hereinafter called “services”) over a given period of time. An (EPG) is an on-screen guide giving information about events on respective services that either are currently being broadcast or are due to be subsequently broadcast. The information typically includes the name of the service and the name and times of the events. It may include further information such as a brief synopsis of the event. An EPG is an example of an MMI (man-machine interface).

To allow generation of the EPG, signalling data representing the content of the EPG is broadcast together with the broadcast television signal. The signalling data may be time-multiplexed within the broadcast television signal as occurs in the DVB standard or may be transmitted on a separate channel as occurs in the ATSC standard. The receiver-decoder apparatus extracts the signalling data and uses it to generate an EPG.

As well as receiving broadcast television signals, receiver-decoder apparatuses are typically provided with interfaces through which they may be supplied with digital video signals from other sources. There are numerous types of such interface but examples include: interfaces for a conditional access module, including such interfaces employing a PCMCIA connector as the physical layer, eg the DVB-CI interface or an interface for a cable card as used in the US; interfaces for connecting a cable capable of carrying a digital video signal; or an interface for a removable memory device such as a memory card. Where such interfaces are provided, the receiver-decoder apparatus will allow the user to select the source of the digital video signal output for supply to the display device as being the broadcast digital television signal received by the receiver circuit or the digital video signal supplied from one of the interfaces.

Currently, television may also be supplied over a network such as the Internet. This is referred to as IPTV (Internet Protocol TV). The question arises as to how to a receiver-decoder apparatus should receive IPTV television signals. In the long term, receiver-decoder apparatuses may incorporate a network interface for receiving IPTV television signals from a network which may be a hard-wired network, eg Ethernet, or a wireless network, eg Wi-Fi.

However, currently most commercially available receiver-decoder apparatuses do not include such a network interface. To adapt such a receiver-decoder apparatus to receive IPTV, it has been proposed to utilise a module having an interface allowing it to be connected to an interface which is provided on the receiver-decoder apparatus. Suitable interfaces include: an interface in accordance with the DVB-CI module as currently provided on all new digital television apparatuses in Europe; or a USB interface. The module also includes a network interface for receiving IPTV television signals from a network. The module therefore receives the IPTV television signal and supplies it to the interface on the receiver-decoder apparatus. Thus the module converts an existing receiver-decoder apparatus to allow reception of an IPTV signal.

However, there is a problem of how the user is to be informed about the events which are available to be watched using an alternative source of video signals other than the broadcast digital television signal received by the receiver circuit. This problem exists in the case of using a module to convert an existing receiver-decoder apparatus to allow reception of an IPTV television signal, as described above, in which case the alternative source of video signals is the video signal derived from the IPTV television signal and supplied through the interface to which the module is connected. This problem also exists more generally in the case of a video signal supplied from any interface which may be provided on the receiver-decoder.

### BRIEF SUMMARY OF THE INVENTION

According to the present invention, there is provided a receiver-decoder apparatus, comprising:

a receiver circuit capable of receiving broadcast television signals of different services;

a decoder circuit capable of decoding a video signal; and

a video interface capable of receiving a video signal, the video interface having connected thereto a module which comprises:
a network interface capable of receiving a video signal from a network; and
a video interface of the same type as, and connected to, the video interface of the receiver-decoder apparatus, the module being arranged to supply a video signal received through the network interface to the video interface for supply to the receiver-decoder apparatus,

the receiver-decoder apparatus being switchable to selectively supply to the decoder circuit either the broadcast television signal received from the receiver circuit or the video signal received from the video interface, and

the receiver-decoder apparatus further comprising an EPG generator operative to extract signalling data broadcast with the broadcast television signal and received by the receiver circuit and to generate therefrom an electronic program guide including a list of the services available for reception by the receiver circuit and events in respect of those services, wherein the EPG generator is arranged to include in the electronic program guide at least one extra entry as a notional service in said list of services in respect of the video signal supplied from the video interface.

By inclusion of the extra entry as a notional service in said list of services, the video signal available from the module via the video interface is identified to the user. This improves the user interface.

The module may generate service data for inclusion in the electronic program guide and transmit the service data to the receiver-decoder apparatus through the video interface for inclusion in said at least one extra entry in said list of services.

The receiver-decoder apparatus may further comprise:

EPG output means for outputting the generated electronic program guide for display; and

control means for receiving user-inputs based on the electronic program guide and controlling the receiver-decoder apparatus in response to those user inputs, the control means being arranged, in response to a user-input selecting said at least one extra entry in said list of services or an event of said at least one extra entry in said list of services, to switch the receiver-decoder apparatus to selectively supply the video signal received from the video interface to the decoder circuit.

In this case, advantageously, said video interface is further capable of carrying commands to the module, the user-inputs include user-inputs selecting a service or an event of a service, and the control means is arranged, in response to a user-input selecting said at least one extra entry in said list of services or an event of said at least one extra entry in said list of services, to output a command to the module through the video interface.

According to further aspects of the invention, there may be provided the receiver-decoder apparatus in isolation or methods corresponding to the operation of the receiver-decoder apparatus.

According to a yet further aspect of the invention, there is provided a receiver-decoder apparatus, comprising:

a receiver circuit capable of receiving broadcast television signals of different services;

a decoder circuit capable of decoding a video signal; and

a video interface capable of receiving a video signal, the receiver-decoder apparatus being switchable to selectively supply to the decoder circuit either the broadcast television signal received from the receiver circuit or the video signal received from the video interface, and the receiver-decoder apparatus further comprising EPG generator operative to extract signalling data broadcast with the broadcast television signal and received by the receiver circuit and to generate therefrom an electronic program guide including a list of the services available for reception by the receiver circuit and events in respect of those services, wherein the electronic program guide means is arranged to include in the electronic program guide at least one extra entry as a notional service in said list of services in respect of the video signal supplied from the video interface

The present invention will now be described in more detail by way of non-limitative example with reference to the accompanying drawings

### BRIEF DESCRIPTION OF THE DRAWINGS

FIG. 1 is a diagram of a receiver-decoder apparatus;

FIG. 2 is a diagram of a module connected to the receiver-decoder apparatus;

FIG. 3 is diagram of a module of an alternative form;

FIG. 4 is a diagram of an EPG; and

FIG. 5 is a diagram of a receiver-decoder apparatus of an alternative form.

By way of example a description will be given of an embodiment working with broadcast television signals in accordance with the DVB standard. First the nature of the broadcast television signals will be described.

### DETAILED DESCRIPTION OF THE INVENTION

According to the DVB standard, what a user might normally call a “channel” is known as a “service”. For example, in the UK, BBC1 would be one service and BBC2 would be another service. Also according to the DVB standard, what a user might normally call a “program” is known as an “event”. These occupy individual time slots within a service. For example, in the UK, an episode of “Newsnight” would represent one event and an episode of “University Challenge” would represent another event. Each service is therefore a concatenation of television events.

According to the DVB standard, the broadcast television signal comprises a stream of packets of data multiplexed together and carried modulated onto a radio frequency (RF) carrier signal in a single RF channel. The stream is sometimes referred to as a channel because it corresponds to a transmission channel. The stream contains packets of video signal data, packets of audio signal data and packets of signalling data. Each packet of signalling data is associated with a particular table, the arrangement and content of which is in accordance with those defined in EN 300 468.

As defined in EN 300 468, each of the signalling data packets has a packet identifier (PID) which designates it as a packet of signalling data, rather than a packet of audio or visual data. Also in each signalling data packet is a table identifier, which designates which table the packet belongs to. Each signalling data packet also contains a “payload”, which contains data about, for example, the network, the services and/or the events. The precise items of data that are stored in a packet depend on which table the packet belongs to, and details of which items of data are given in packets belonging to a particular table can be found in EN 300 468. For present purposes it is noted that the signalling data includes the following information which can be extracted for use as the content of an EPG:

a Service Description Table (SDT) which gives information on services which are being transmitted, including the names of the services; and

an Event Information Table (EIT) which gives information on the events in respect of each service, including the names and times of the respective events.

In this example, the broadcast television signals are encoded in accordance with the MPEG-2 standard. In this case, each broadcast RF channel comprises a plurality of services multiplexed together.

Although an embodiment using the DVB standard is described herein, the embodiment could equally be applied to alternative standards, such as the ARIB standard (for example, in Japan), or the ATSC standard (for example, in the United States). Such alternative standards transmit equivalent information which can be extracted and utilised in an equivalent manner to that described below.

FIG. 1 shows a receiver-decoder apparatus 1 which is capable of receiving and decoding broadcast television signals in accordance with the DVB standard and the MPEG-2 standard. In this case the receiver-decoder apparatus 1 is a television including a display device 10 but this is not essential. For example the receiver-decoder apparatus 1 could have no display device and instead output a video stream for supply to a separate television apparatus. In this case, the receiver-decoder apparatus 1 might be a set-top box or a recoding apparatus including a recording device for recording a video signal.

The receiver-decoder apparatus 1 is connected to an external antenna 3 in a conventional manner. The receiver-decoder apparatus 1 has a receiver circuit 4 which is supplied with a radio frequency television broadcast signal received by the antenna 3.

The receiver circuit 4 comprises an RF tuner 5 which extracts the desired broadcast signal and a demodulator 6 which demodulates the broadcast signal to extract a multiplexed signal of a single broadcast channel.

In this example, the broadcast digital television signal is a terrestrial signal transmitted on a RF carrier. As an alternative the broadcast digital television signal could be a satellite signal or a cable signal, in which case the antenna 3 and receiver circuit 4 are adapted in a conventional manner to receive such signals.

As is conventional for broadcast digital television, each broadcast channel carries a multiplexed signal in which a plurality of video streams and associated audio and data streams, commonly referred to as services, are multiplexed together. The video stream extracted by the demodulator 8 is supplied to a switch 12 (described further below) which may be switched to pass that video stream on to a demultiplexer 8. The demultiplexer 8 demultiplexes the packets of data in the video stream to extract one or more video signals, one or more audio signals and signalling data.

The video signal extracted by the demultiplexer 8 is supplied to an MPEG-2 decoder 9 for decoding the video stream in accordance with the MPEG-2 standard. The MPEG-2 decoder 9 outputs an uncompressed video stream which is supplied to the display device 10 which displays the video images of the video stream, or in the case that the display device 10 is absent is output from the receiver-decoder apparatus 1 for supply to a television apparatus.

The receiver-decoder apparatus 1 includes a controller 13 which controls the operation of the components of the receiver-decoder apparatus 1. The controller 13 is implemented by a microprocessor running an appropriate program. The controller 13 controls the receiver circuit 4 and the demultiplexer to select the broadcast video signal of a desired service. The controller 13 also controls the switch 12.

The receiver-decoder apparatus 1 also has a memory such as a RAM.

The receiver-decoder apparatus 1 also includes an IR (infra-red) receiver unit 16 capable of receiving signals from a remote commander 17. The remote commander 17 is operated by a user to provide user-inputs to the receiver-decoder apparatus 1.

In this example, the receiver-decoder apparatus 1 is legacy equipment which is not in itself capable of receiving television over a data network such as the Internet, referred to herein as IPTV (Internet Protocol Television). To convert the receiver-decoder apparatus 1 to allow reception of IPTV, a module 20 is connected to the receiver-decoder apparatus 1.

The module 20 conforms with the DVB-CI standard. Accordingly, the module 20 has a PCMCIA connecter 21 conforming with the PCMCIA standard to allow it to connect to a PCMCIA slot being the physical layer of a video interface 15 provided in the receiver-decoder apparatus 1. The video interface 15 is in accordance with the DVB-CI standard. DVB-CI stands for Digital Video Broadcasting-Common Interface. In order to allow connection of a Conditional Access Module (CAM) which can descramble scrambled video streams, it is very common for a receiver-decoder apparatus to be provided with such a video interface 15 in accordance with the DVB-CI standard and including a slot in accordance with the PCMCIA standard.

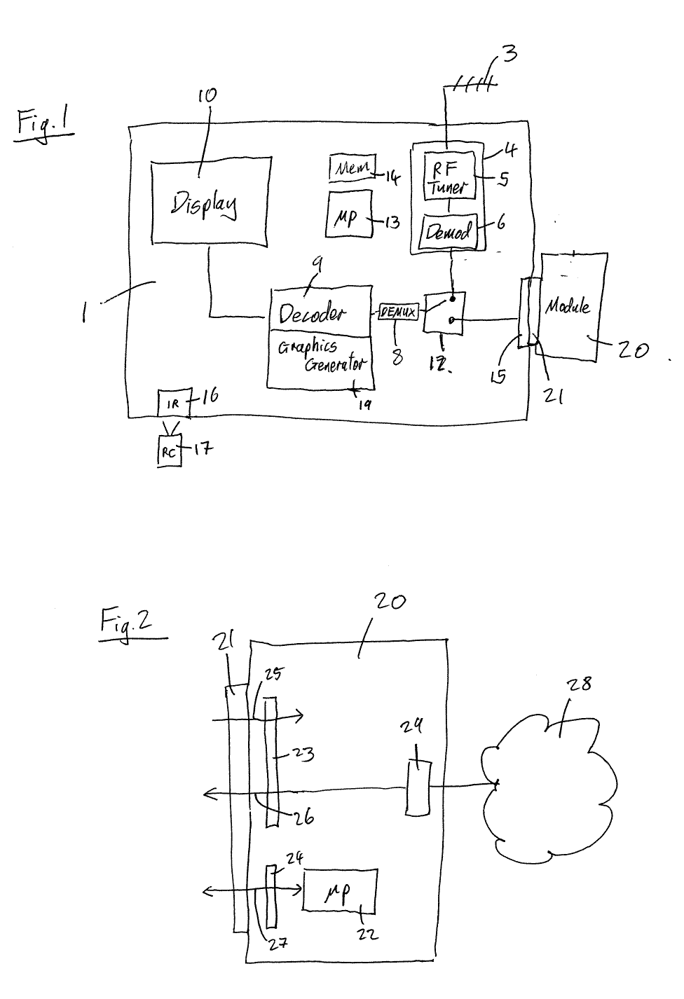

FIG. 2 shows the arrangement of the module 20. The module 20 includes a controller 22 which controls the operation of the components of the module 20. The controller 22 is implemented by a microprocessor running an appropriate program.

In accordance with the DVB-CI standard, the module 20 further includes a transport stream interface 23 and a command interface 24. The transport stream interface 23 which includes the PCMCIA connector 11 as part of the physical layer is capable of receiving an input video signal 25 and transmitting an output video signal 26. The command interface 24 is capable of bidirectionally transferring commands 27. Received commands 27 are supplied to the controller 22 which also is capable of generating commands 27 and transmitting them over the command interface 24.

The module 20 further includes a network interface 29 arranged to receive data from a data network 28 and to extract an IPTV video stream. The network 28 and the corresponding network interface 29 may be of any type including a wired network or a wireless network. The network interface 29 may include a stack of protocols to handle data transmitted over the data network 28 in different formats.

An important example is that the network 28 is the Internet. In this case, the network interface 29 includes a physical connector such an Ethernet connector and includes protocols such as TCP/IP for receiving video streams over the Internet. This example allows the module 20 to receive IPTV directly.

Another important example of the network 28 is a wireless local area network (LAN) such as Wi-Fi. In this case, one possibility is that another device such as a computer or an IPTV gateway may receive an IPTV video stream transmitted over the internet and then pass the IPTV video stream to a wireless LAN transmitter which transmits the video stream over the wireless LAN 28. In this case, network interface 29 includes an antenna which receives the video stream from the wireless LAN 28 and includes protocols for the wireless LAN 28. This is another useful implementation of the module 20 for receiving IP-TV.

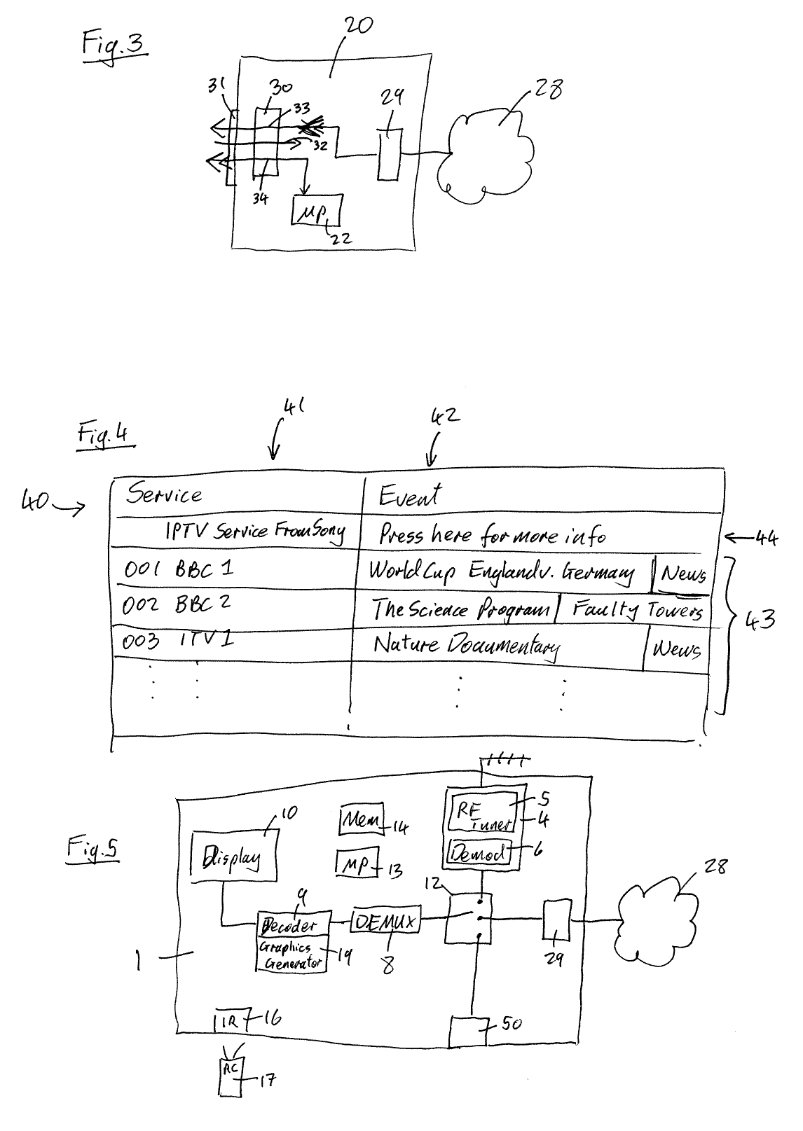

The module 20 may take a form in accordance with a standard other than the DVB-CI standard. An example of such an alternative form of the module 20 is shown in FIG. 3. In this example, the module 20 has, instead of the transport stream interface 23 and the command interface 24 in conformity with the DVB-CI standard, a USB interface 30 in accordance with the USB standard and including a USB connector 31 as part of the physical layer. In this case the video interface 15 on the televison receiver-decoder apparatus is modified to be in accordance with the USB standard. The USB interface 30, in a time-multiplexed manner, (1) bidirectionally receives input video signals 32, (2) transmits the output video signals 33 and (3) transmits commands 34 bidirectionally. The other components of the module 20 in this alternative form are the same as shown in FIG. 2 and described above. Thus the video stream received through the network interface 29 is output through the USB interface 30 to the receiver-decoder apparatus 1 and the operation of the module 20 is controlled by the controller 22.

The video stream received by the receiver-decoder apparatus 1 from the module is supplied to the switch 12. The switch 12 is switchable to selectively supply the demultiplexer 8 and the decoder 9 with the video stream from the module 20 or the video stream from the receiver circuit 4. Thus the source of the video signal output from the decoder 8 for display on the display device 10 can be selected.

Generation and use of an EPG (electronic program guide) 40, an example of which is shown in FIG. 4, is implemented by the controller 13 as will now be described. The controller 13 generates the EPG 40 and stores it in the memory 14. The EPG 40 includes a list of services and events in respect of those services. As shown in the example of FIG. 4, the EPG 40 may have a service field 41 storing the name of the service and an events field 42 storing information about the events including the names and times of the events.

The format of the EPG 40 may be freely designed by the manufacturer of the receiver-decoder apparatus 1 to provide a desired look and feel.

The content of the EPG 40 in respect of the broadcast television signals which may be received by the receiver circuit 4 is derived from the signalling data received by the receiver circuit 4 of the receiver-decoder apparatus 1 and output by the demultiplexer 8. The controller 8 extracts this signalling data output by the demultiplexer 8 and uses it to populate the EPG 40. Thus the EPG 40 includes a list 43 of services available for reception by the receiver circuit 4. Such content is conventional for an EPG in a receiver-decoder apparatus.

In addition 40, the EPG 40 includes an extra entry 44 in the list of services in respect of the video signal available from the module 20. This entry 44 has the same format as the list 43 of services available for reception by the receiver circuit 4 and so appears to the user as a further, notional service. In particular the entry 44 includes the name of the notional service in the service field 41 and information in the event field 42. The content of the entry 44 in respect of the video signal available from the module 20 is extracted from service data supplied by the module 20. In this manner, the content of the entry 44 is dynamic.

In this example, the controller 22 of the module 20 generates the service data, possibly on the basis of information supplied over the network 28 through the network interface 29. The controller 22 of the module 20 then packages the service data in packets in accordance with the DVB standard and hence in the same format as the signalling data received by the receiver circuit 4 as part of the broadcast television signal, for example in an SDT and an EIT. In this manner, the controller 13 of the receiver-decoder apparatus 1 can extract the service data using the demultiplexer 8 when the switch 12 is switched to the video interface 15 in the same manner as for the broadcast television signal. This is a particularly convenient implementation, but in general terms the service data could be transmitted from the module 20 to the receiver-decoder apparatus 1 in any manner, for example over the command interface 24 or as a special packet of data.

The controller 13 effects use of the EPG 40 as follows, in response to a user-input from the remote commander 17 selecting the EPG 40.

The decoder 9 includes a graphics generator 19. The controller 13 controls the graphics generator 19 to generate graphics representing the EPG 40 stored in the memory. These graphics may be superimposed on or mixed with the video signal output by the decoder 9, so that they are displayed on the display device 10. Alternatively, these graphics may be output from the decoder 9 separately from the output video signal for display on the display device 10. Thus the user can view the EPG 40 on the display device 40.

The format of the displayed EPG 40 is changed by the controller 13 in response to user-inputs from the remote commander 17 to provide a graphical user interface (GUI). In particular a curser on the displayed EPG may be moved in response to user-inputs to high-light different services and/or events in the EPG 40.

The controller 13 is also responsive to user-inputs from the remote commander 17 which select services and/or events in the EPG 40. In this case, the controller 13 controls the receiver-decoder apparatus 1 as follows.

When the user selects a service in the list 43 of services available for reception by the receiver circuit 4 or an event thereof, the controller 13 controls the receiver circuit 4 to receive the selected service and switches the switch 12 to the supply the video stream from the receiver circuit 4 to the demultiplexer 8 and decoder 9. Thus the video signal of the selected service is displayed on the display device 10. Where a future event is selected, this operation may be performed subsequently at the time of the event.

When the user selects a service in the extra entry 44 in the list of services in respect of the video signal available from the module 20, the controller 13 performs the following action.

Firstly, the controller 13 switches the switch 12 to the supply the video stream from the video interface 15 to the demultiplexer 8 and decoder 9. Thus the video signal of the IPTV television signal received by the module 20 is displayed on the display device 10.

Secondly, the controller 13 outputs a command to the module 20 through the video interface 15. The command instructs the module 20 that the video signal supplied by the module 20 has been selected. In response to that command, the controller 22 of the module 20 implements a man-machine interface (MMI) to control the supply of the IPTV television signal to the receiver-decoder apparatus 1. The MMI may include a number of different features, for example as follows.

The MMI may involve the display of GUI to the user under the control of the controller 22 of the module 20. This may be achieved in several different ways, for example as follows.

A first way of providing a GUI is for the controller 22 of the module 20 to supply commands over the command interface 24 to the receiver-decoder apparatus 1 to make use of MMI resources on the receiver-decoder apparatus 1 to present the GUI on the display device 10. This process is in accordance with the DVB-CI standard.

A second way of providing a GUI is for the controller 22 of the module 20 to insert graphics on the video signal supplied to the receiver-decoder apparatus 1 in the manner described in co-pending British Patent Application No. 0609052.6.

A third way of providing a GUI is for the controller 22 of the module 20 to transmit to the receiver-decoder apparatus 1 a video signal containing command in HTML format. The receiver-decoder apparatus 1, in response to these commands, executes an application to generate the GUI.

The GUI may include a further EPG in respect of the services available for reception over the network 29.

The MMI may also involve the controller 22 of the module 20 being responsive to user-inputs to control the operation of the module 20. Such user-inputs are made using the remote commander 17 and received at the IR receiver unit 16. The receiver-decoder apparatus 1 then transmits the user-inputs to the module 20 over the command interface 24. Such user-inputs may control any aspect of the operation of the module 20, for example to change the IPTV signal received by the module 20 and supplied to the receiver-decoder apparatus 1, or to cause the module 20 to interact over the data network 29 with the source of the IPTV signals.

There will now be described an alterative form of the receiver-decoder apparatus 1 shown in FIG. 5. In this alternative form, the capability of receiving IPTV television signals is incorporated into the receiver-decoder apparatus 1. The receiver-decoder apparatus 1 in this alternative form is the same as shown in FIG. 1 and described above, except for the modifications described below. Common elements are given common reference numerals and for brevity a description thereof is not repeated.

To allow reception of IPTV television signals, the receiver-decoder apparatus 1 incorporates the network interface 29 arranged to receive data from a data network 28 and to extract an IPTV video stream. The network interface 29 is the same as that provided in the module 20 as shown in FIG. 2 and described above. Thus the module 20 is unnecessary and not present. The IPTV video stream extracted by the network interface is supplied to the switch 12.

The receiver-decoder apparatus 1 also incorporates an additional video interface 50 arranged to receive a video signal. The additional video interface 50 may be of any numerous different types, including: an interface for a conditional access module, including such as an interface employing a PCMCIA connector as the physical layer, eg the DVB-CI interface or an interface for a cable card as used in the US; an interface for connecting a cable capable of carrying a digital video signal, eg an HDMI interface; or an interface for a removable memory device such as a memory card. The video signal from the additional video interface 50 is supplied to the switch 12.

The switch 12 under the control of the controller 13 can selectively supply to the demultiplexer 8 and the decoder 9 the video signal from any of the receiver circuit 4, the network interface 29 or the additional video interface 50.

The receiver-decoder apparatus 1 in the alternative form is arranged to operate in fundamentally the same manner as described above except that the network interface 29 is now also controlled by the controller 13 and there is an additional video source from the additional video interface 50.

Thus the EPG 40 is generated and used as described above with an extra entry 44 in the list of services in respect of the video signal from the network interface 29. The may also be an extra entry in respect of the video signal from the additional video interface 50. The content of the extra entries may be derived from service data supplied over the network interface 29 or the additional video interface 50 so that it is dynamic, or may alternatively be pre-set in the receiver-decoder apparatus 1.

When either of the extra entries in the EPG 40 are selected by the user-inputs from the remote commander 17, the controller 13 switches the switch 12 to the supply to the demultiplexer 8 and decoder 9 the video stream from corresponding one of the network interface 29 or the video interface 50 so the corresponding video signal is displayed on the display device 10.

Furthermore, the controller 13 may implement an MMI to control the reception of video streams from the network interface 29 or the video interface 50.

1. A receiver-decoder apparatus, comprising:
a receiver circuit capable of receiving broadcast television signals of different services;
a decoder circuit capable of decoding a video signal; and
a video interface capable of receiving a video signal, the video interface having connected thereto a module which comprises:
a network interface capable of receiving a video signal from a network; and
a video interface of the same type as, and connected to, the video interface of the receiver-decoder apparatus, the module being arranged to supply a video signal received through the network interface to the video interface for supply to the receiver-decoder apparatus,
the receiver-decoder apparatus being switchable to selectively supply to the decoder circuit either the broadcast television signal received from the receiver circuit or the video signal received from the video interface, and
the receiver-decoder apparatus further comprising an EPG generator operative to extract signalling data broadcast with the broadcast television signal and received by the receiver circuit and to generate therefrom an electronic program guide including a list of the services available for reception by the receiver circuit and events in respect of those services, wherein the EPG generator is arranged to include in the electronic program guide at least one extra entry as a notional service in said list of services in respect of the video signal supplied from the video interface.

2. A receiver-decoder apparatus according to claim 1, wherein
the module further comprises a service data generator operative to generate service data for inclusion in the electronic program guide and to transmit the service data to the receiver-decoder apparatus through the video interface, and
said at least one extra entry in said list of services from said service data included by the EPG generator includes said service data.

3. A receiver-decoder apparatus according to claim 2, wherein said service data includes a name of the notional service and data in respect of events of the notional service.

4. A receiver-decoder apparatus according to claim 2, wherein the service data generator is operative to transmit the service data in the same format as the signalling data broadcast with the broadcast television signal.

5. A receiver-decoder apparatus according to claim 1, wherein the receiver-decoder apparatus further comprises:
an EPG output for outputting the generated electronic program guide for display; and
a controller operative to receive user-inputs based on the electronic program guide and to control the receiver-decoder apparatus in response to those user inputs, the controller being arranged, in response to a user-input selecting said at least one extra entry in said list of services or an event of said at least one extra entry in said list of services, to switch the receiver-decoder apparatus to selectively supply the video signal received from the video interface to the decoder circuit.

6. A receiver-decoder apparatus according to claim 5, wherein
said video interface is further capable of carrying commands to the module, and
the controller is arranged, in response to a user-input selecting said at least one extra entry in said list of services or an event of said at least one extra entry in said list of services, to output a command to the module through the video interface.

7. A receiver-decoder apparatus according to claim 6, wherein the module further comprises an MMI interface generator operative to implement a man-machine interface in response to receipt of said command.

8. A receiver-decoder apparatus according to claim 1, wherein the EPG generator is arranged to store the generated electronic program guide in a memory of the receiver-decoder apparatus.

9. A receiver-decoder apparatus according to claim 1, wherein the network interface is an IP interface.

10. A receiver-decoder apparatus according to claim 1, wherein the network is a hard-wired network or a wireless network.

11. A receiver-decoder apparatus according to claim 1, wherein the video interface includes a physical connector in accordance with the PCMCIA standard.

12. A receiver-decoder apparatus according to claim 11, wherein the video interface is in accordance with the DVB-CI standard.

13. A receiver-decoder apparatus according to claim 1, wherein the video interface is in accordance with the USB standard.

14. A receiver-decoder apparatus, comprising:
a receiver circuit capable of receiving broadcast television signals of different services;
a decoder circuit capable of decoding a video signal; and
a video interface capable of receiving a video signal,
the receiver-decoder apparatus being switchable to selectively supply to the decoder circuit either the broadcast television signal received from the receiver circuit or the video signal received from the video interface, and
the receiver-decoder apparatus further comprising EPG generator operative to extract signalling data broadcast with the broadcast television signal and received by the receiver circuit and to generate therefrom an electronic program guide including a list of the services available for reception by the receiver circuit and events in respect of those services, wherein the electronic program guide means is arranged to include in the electronic program guide at least one extra entry as a notional service in said list of services in respect of the video signal supplied from the video interface.
